(19) United States
(12) Patent Application Publication
(10) Pub. No.: US 2023/0046385 A1
(43) Pub. Date: Feb. 16, 2023

(54) STEAM COOKING METHOD

(71) Applicant: MABE, S.A. DE C.V., Querétaro (MX)

(72) Inventors: Juan Gerardo JAIME VENTURA, Querétaro (MX); Guillermo ROCHA AGUILERA, Querétaro (MX)

(21) Appl. No.: 17/683,563

(22) Filed: Mar. 1, 2022

(30) Foreign Application Priority Data
Aug. 12, 2021 (MX) MX/A/2021/009721

(51) Int. Cl. F24C 15/00; A47J 27/04

(52) U.S. Cl. CPC F24C 15/003; A47J 27/04; A47J 2027/043

(57) ABSTRACT

The present invention relates to a water-injection device for an oven comprising a removable water tank in connection with a pressure pump; said pressure pump being in connection with a water injector.

### SUBJECT MATTER OF THE INVENTION

The present invention relates to a water-injection device for a cooking unit with a simple arrangement in its construction and is applied to food cooking units such as kitchen ovens and similar appliances to generate the steam necessary to cook food in said appliances.

### BACKGROUND

Equipment for cooking food such as ovens and similar appliances are known from the prior art, which comprise a closed cavity provided with a fan and at least one gas-fired or electrically powered heating element, in which the food to be cooked is placed under the action of a forced circulation of hot air or steam, or a combination of hot air and steam, said forced circulation being induced by the rotation of said fan and caused to flow through said heating element(s), while the steam is generated in a separate boiler, which is connected with said closed cavity of the oven, or by letting water enter said chambers on the suction side of said fan, which then directs said water against the outer surface of said heating element(s), where it therefore vaporizes instantly.

The purpose of the present invention is the use of a water-injection device for generating steam for cooking food, which is provided with the characteristics that are substantially described with particular reference to the appended claims.

### BRIEF DESCRIPTION OF THE INVENTION

The present invention refers to a water-injection device for an oven, said water-injection device comprises a removable water tank in connection with a pressure pump; a water injector arranged on a vertical wall of a cooking compartment of the oven, said pressure pump being in connection with the water injector; so that the water supplied by said water injector into the cooking compartment evaporates due to the heat generated by said oven inside the cooking compartment, thus generating steam.

Additionally, the invention also relates to a steam-assisted cooking unit comprising a cooking compartment with a door defining an internal space; and a water-injection device, said water-injection device comprises a removable water tank in connection with a pressure pump; and a water injector arranged on a vertical wall of said cooking compartment, said pressure pump being in connection with the water injector; so that the water supplied by said water injector into the cooking compartment evaporates due to the heat generated by said oven inside the cooking compartment, thus generating steam.

Additionally, the invention refers to a stove comprising a plurality of heating elements and a cooking unit as described in the previous paragraph.

The present invention is suitable for various modifications and alternative constructions, some of which are detailed in the drawings below. However, it should be clear that the intention is not to limit the invention to a particular embodiment or form, but rather the present invention should cover changes, additions and modifications as part of its scope. Independent aspects and advantages of the present invention will become apparent to those skilled in the art upon review of the detailed description and figures.

### BRIEF DESCRIPTION OF THE FIGURES

The illustrative embodiment can be described with reference to the accompanying figures, which relate to:

FIG. 1 is a perspective view of the water-injection device for a cooking unit of the present invention;

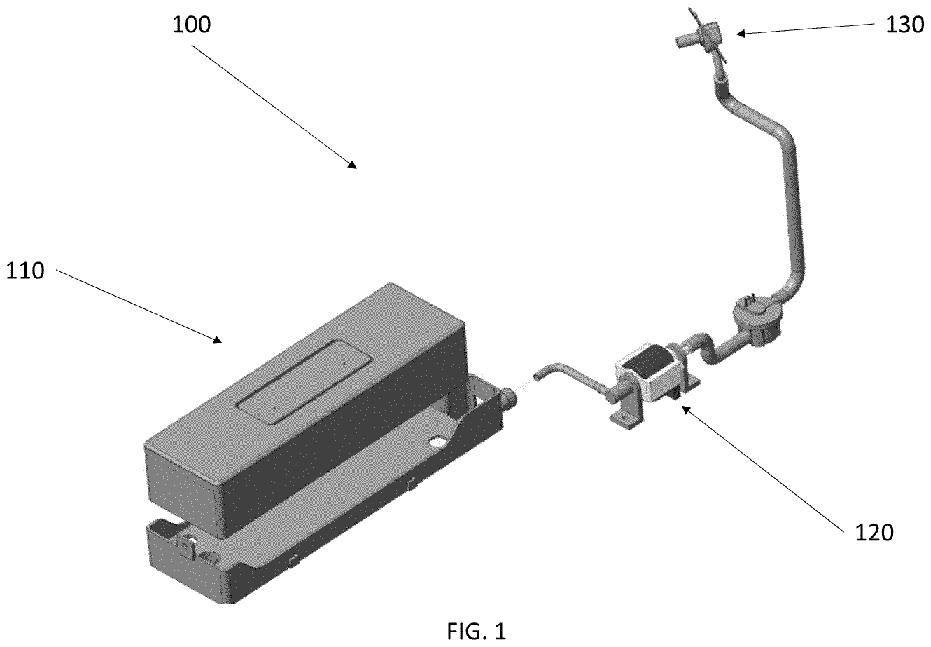

FIG. 2 is an exploded view of the water-injection device for a cooking unit of the present invention;

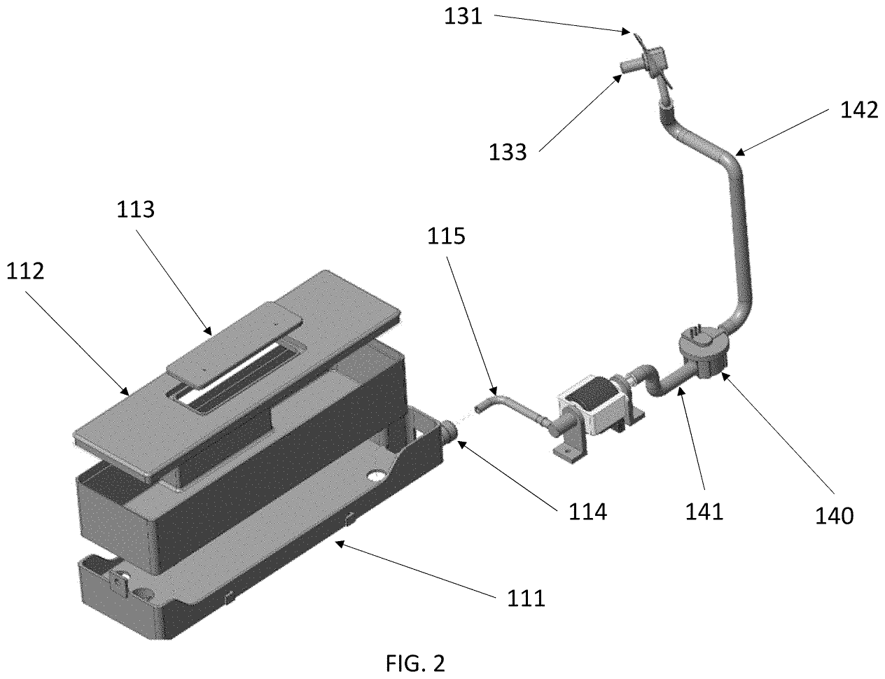

FIG. 3 is a front view of the water-injection device for a cooking unit of the present invention arranged in a first location of a cooking unit;

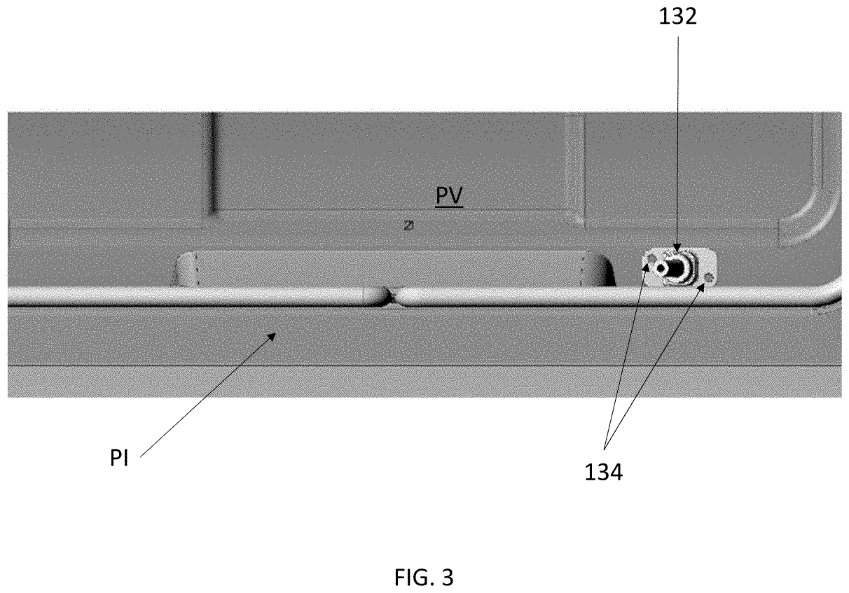

FIG. 4 is a front view of the water-injection device for a cooking unit of the present invention arranged in a second location of a cooking unit;

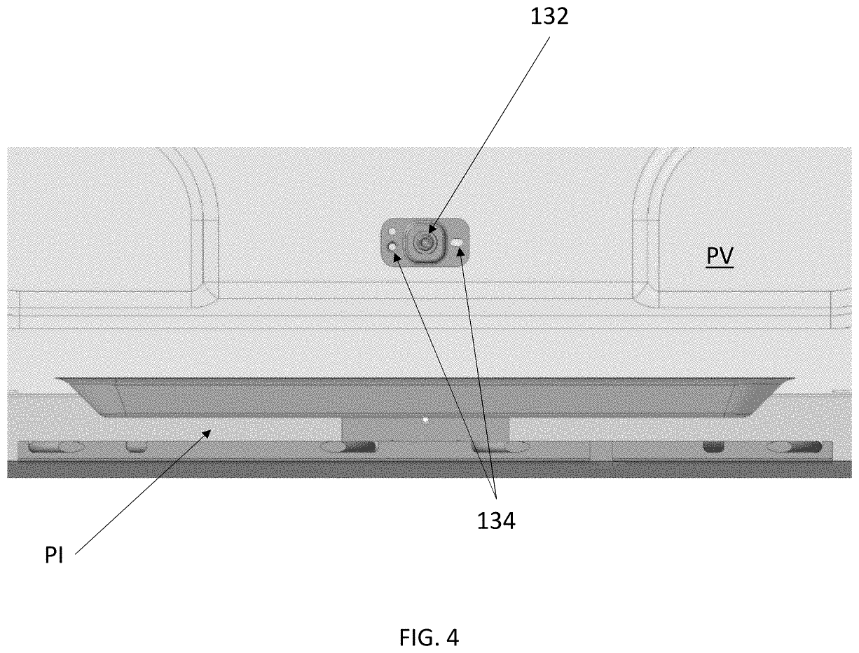

FIG. 5 is a top view of the water-injection device for a cooking unit of the present invention arranged in a first location of a cooking unit;

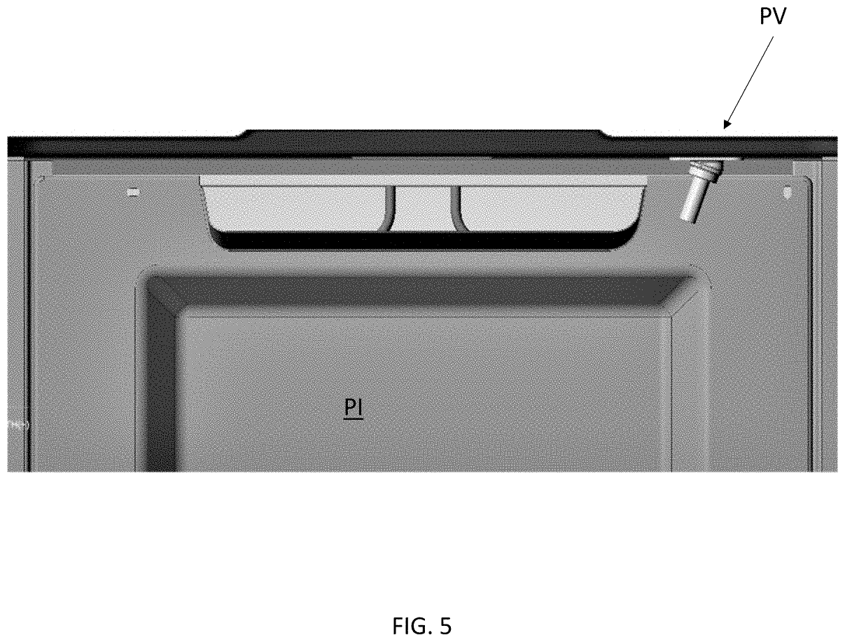

FIG. 6 is a top view of the water-injection device for a cooking unit of the present invention arranged in a second location of a cooking unit;

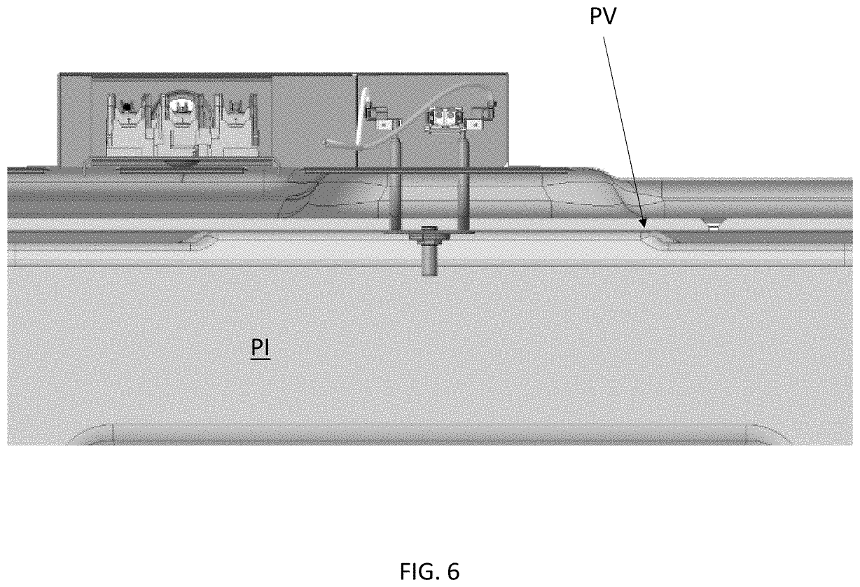

FIG. 7 is a perspective view of a cooking unit with two water-injection devices.

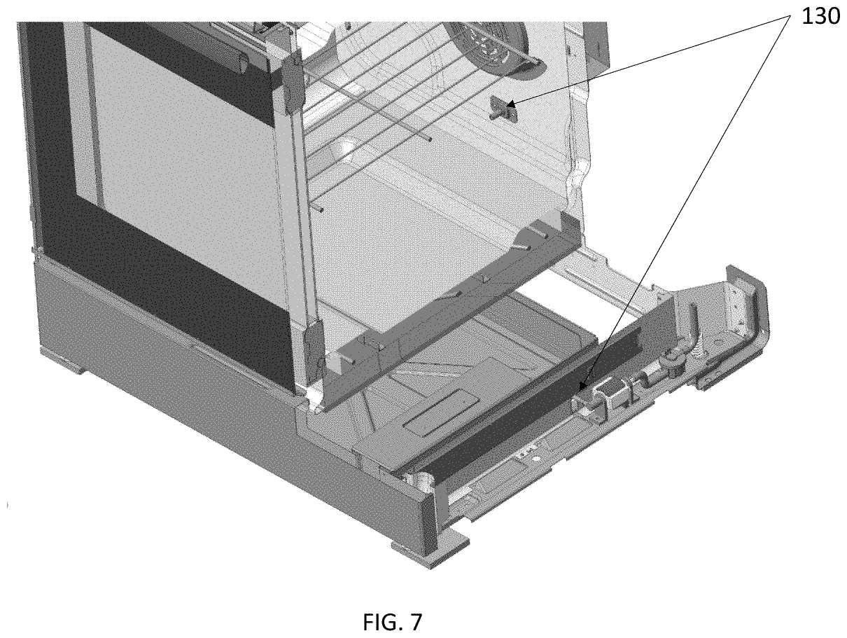

The accompanying Figures are included to provide further illustration and understanding of the various aspects and embodiments, and are incorporated into and constitute a part of this description. The Figures, together with the description, serve to explain the aspects and embodiments described and claimed.

### DETAILED DESCRIPTION OF THE INVENTION

The following detailed description is exemplary only and is not intended to limit the disclosed embodiments or the application and uses of the described embodiments. As used herein, the word “exemplary” or “illustrative” means “serving as an example, instance, or illustration”. Any implementation described herein as “exemplary” or “illustrative” should not necessarily be construed as preferred or advantageous over other implementations. All of the implementations described below are exemplary implementations provided to enable those skilled in the art to make or use the embodiments of the disclosure and are not intended to limit the scope of the disclosure. For the purposes of the present description, the terms “upper”, “lower”, “left”, “posterior”, “right”, “front”, “vertical”, “horizontal” and their derivatives will refer to the invention as oriented in the figures.

Additionally, the term “approximately” determines a range±5%, for example, if in the description a range of approximately 10° C. to approximately 20° C. is defined, said range is within the range of 9.5° C. to 21° C.

Furthermore, there is no intention to be subject to any explicit or implicit theory presented in the technical field above, background, brief summary or the following detailed description. It should also be understood that the specific devices and processes illustrated in the accompanying drawings, and described in the following specification, are simply exemplary embodiments of the inventive concepts defined in the attached claims. Therefore, the specific dimensions and other physical characteristics related to the embodiments described herein should not be considered as limiting, unless the claims expressly state otherwise.

The water-injection device (100) for a cooking unit of the present invention comprises a removable water tank (110) in connection with a pressure pump (120), said removable water tank (110) is arranged in a non-removable base (111), the removable water tank (110) comprises at least one first removable cover (112), which is removable for the purpose of cleaning or performing maintenance on said removable water tank (110), said at least one first removable cap (112) has a second cap (113) thereon, said second cap (113) functions as a filling cap, wherein the removable water tank (110) comprises a quick connector (114) that is coupled with a hose (115), said hose (115) makes the connection with the pressure pump (120). Said non-removable base (111) is in a different location from the internal space of the compartment of the cooking unit and in communication with same; said non-removable base (111) corresponds to a means for locating the removable water tank (110) and prevents water spillage; the first and second caps (112, 113) are fastened together by pressure fitting or by sealing.

The pressure pump (120) is in connection with a water injector (130), a flow meter (140) is arranged between the pressure pump (120) and the water injector (130), the connection between the pressure pump (120) and flow meter (140) is made by means of a first silicone hose (141), the connection between the flow meter (140) and the water injector (130) is made by a second silicone hose (142).

The flow meter (140) measures and detects the amount of liquid flowing through or around the flow meter (140), thereby providing accurate and repeatable flow measurements; the flow meter (140) indicates the existence of water in the removable water tank (110).

The water injector (130) has a fastener (131) comprising a plate with a central perforation (132) through which a nozzle (133) of said water injector (130) and two lateral perforations (134) pass.

The fastener (131) of said water injector (130) serves to arrange said water injector (130) on a vertical wall (PV) of the cooking compartment of said cooking unit near a floor (PI) of the cooking compartment of said cooking unit; so that the water supplied by said water injector (130) into the cooking compartment evaporates due to the heat generated by said cooking unit inside the cooking compartment, thereby generating steam. The water injector (130) has an inclination of between approximately 80° and approximately 125° with respect to the vertical wall (PV) of the internal space of the cooking compartment of the cooking unit where said injector is arranged.

In an alternative embodiment, at least one water-injection device (100) of the present invention is arranged in a cooking unit, said cooking unit has a cooking compartment with a door that defines an internal space. The at least one water-injection device (100) shoots a jet of water onto the floor of the cooking unit, in an alternative embodiment, said at least one water-injection device (100) injects a water spray.

Additionally, between the removable water tank (110) and the pressure pump (120) there is a safety valve (not shown), which closes when removing or inserting the removable water tank (110) to avoid spilling water.

In one embodiment, the at least one water-injection device (100) of the present invention is arranged in a cooking unit arranged in a stove (not shown). Said cooking unit is chosen from the group comprising an oven without burners, a unit with a double oven and a separate unit for steam cooking only.

In a further embodiment, the cooking unit is located in a stove that has a plurality of heating elements, said heating elements comprise at least one of electric elements and gas burner elements, the electric elements comprise at least one of induction elements and radiant elements.

A person skilled in the art can modify the structure described herein. However, it should be noted that this description relates to preferred embodiments of the invention, and is provided for illustrative purposes only, and should not be understood as limiting the invention. All obvious modifications in the spirit of the invention, such as changes in the shape, material, and dimensions of the elements that make up the invention, should be considered within the scope of the attached claims.

The invention has been described in an illustrative manner and it should be understood that the terminology, which has been used herein, is intended to correspond to the nature of the words of description rather than to provide a limitation.

Obviously, many modifications and variations of the present invention are possible in light of the above teachings. Therefore, it should be understood that within the scope of the invention described, the invention may be practiced otherwise than specifically described.

1. A water-injection device for a cooking unit, said water-injection device comprises:
a removable water tank in connection with a pressure pump;
a water injector arranged on a vertical wall of a cooking compartment of the cooking unit, said pressure pump being in connection with the water injector;
so that the water supplied by said water injector into the cooking compartment evaporates due to the heat generated by said cooking unit inside the cooking compartment, thus generating steam.

2. The water-injection device for a cooking unit according to claim 1, wherein the removable water tank comprises at least one removable cap, wherein said at least one removable cap has a secondary cap thereon.

3. (canceled)

4. The water-injection device for a cooking unit according to claim 1, wherein the removable water tank is arranged on a non-removable base.

5. The water-injection device for a cooking unit according to claim 1, wherein the removable water tank comprises a quick connector that is coupled with a hose, said hose in connection with the pressure pump.

6. The water-injection device for a cooking unit according to claim 1, wherein a flow meter is arranged between the pressure pump and the water injector.

7. The water-injection device for a cooking unit according to claim 6, wherein the connection between the pressure pump and the flow meter is made by means of a first silicone hose.

8. The water-injection device for a cooking unit according to claim 6, wherein the connection between the flow meter and the water injector is made by means of a second silicone hose.

9. A steam-assisted cooking unit comprising:
a cooking compartment with a door defining an internal space; and
at least one water-injection device, said at least one water-injection device comprises:
a removable water tank in connection with a pressure pump; and
a water injector arranged on a vertical wall of said cooking compartment, said pressure pump being in connection with the water injector;
so that the water supplied by said water injector into the cooking compartment evaporates due to the heat generated by said cooking unit inside the cooking compartment, thus generating steam.

10. The steam-assisted cooking unit according to claim 9, wherein the removable water tank comprises at least one removable cap.

11. The steam-assisted cooking unit according to claim 9, wherein said at least one removable cap has a secondary cap thereon.

12. The steam-assisted cooking unit according to claim 9, wherein the removable water tank is arranged on a non-removable base.

13. The steam-assisted cooking unit according to claim 9, wherein the removable water tank comprises a quick connector that is coupled with a hose, said hose in connection with the pressure pump.

14. The steam-assisted cooking unit according to claim 9, wherein a flow meter is arranged between the pressure pump and the water injector.

15. The steam-assisted cooking unit according to claim 14, wherein the connection between the pressure pump and the flow meter is made by means of a silicone hose.

16. The steam-assisted cooking unit according to claim 14, wherein the connection between the flow meter and the water injector is made by means of a silicone hose.

17. The steam-assisted cooking unit according to claim 9, wherein the removable water tank is located in the internal space of the cooking compartment of the cooking unit.

18. The steam-assisted cooking unit according to claim 9, wherein the water injector is arranged near a floor of the internal space of the cooking compartment of the cooking unit.

19. The steam-assisted cooking unit according to claim 9, wherein the water injector has an inclination of between approximately 80° and approximately 125° with respect to the wall of the internal space of the cooking compartment of the cooking unit where said injector is arranged.

20. A stove that includes:
a plurality of heating elements; and
at least one steam-assisted cooking unit.

21. (canceled)

22. The stove according to claim 20, wherein the plurality of heating elements comprise at least one of electric elements and gas burner elements, wherein the electrical elements comprise at least one of induction elements and radiant elements.
